(19) United States
(12) Patent Application Publication
(10) Pub. No.: US 2011/0234389 A1
(43) Pub. Date: Sep. 29, 2011

(54) Guidance and collision warning device for forklift trucks

(75) Inventor: Tom Mellin, Porvoo (FI)

(73) Assignee: Deutsche Post AG, Bonn (DE)

(21) Appl. No.: 13/128,451

(22) PCT Filed: Nov. 9, 2009
(86) PCT No.: PCT/EP2009/007993

§ 371 Date: Jun. 14, 2011

(30) Foreign Application Priority Data
Nov. 11, 2008 (EP) 08019693.4

(51) Int. Cl. B60Q 1/00

(52) U.S. Cl. 340/435

(57) ABSTRACT

There is provided a forklift truck for lifting and moving goods placed on a palette. An exemplary forklift truck comprises a lifting device that is vertically positioned with a lift pole. The lifting device comprises a horizontal bar to which at least two parallel forks are fixed. The forklift truck also comprises a guidance system that includes at least one optical positioning aid, and a central processing unit to which the rangefinder units are connected. The guidance system further comprises at least three rangefinder units for measuring range data. One of the at least three rangefinder unit is located at each front-end of the two forks. Additionally, one of the at least three rangefinder units and one optical positioning aid are located at the horizontal bar of the lifting device.

### CROSS-REFERENCE TO RELATED APPLICATIONS

Pursuant to 35 U.S.C. §371, this application is the United States National Stage Application of International Patent Application No. PCT/EP2009/007993, filed on Nov. 9, 2009, the contents of which are incorporated by reference as if set forth in their entirety herein, which claims priority to European (EP) Patent Application No. 08 019 693.4, filed Nov. 11, 2008, the contents of which are incorporated by reference as if set forth in their entirety herein.

### BACKGROUND

Collision warning systems, especially with short ranged supersonic sensors are known in the state of the art in numerous applications, like car parking sensors for example. The applicability of this technique in the field of forklift trucks is known as well. The European patent application EP 1 293 472 A2 describes a forklift truck with a collision warning system, in which a supersonic sensor mounted at the base of the forks detects the distance to an object which is picked up with the forks. To avoid damage to objects which stand behind the object that is actually picked up, the system is equipped with an alert function which produces an acoustic warning signal, if a predefined distance is reached. However, it could be regarded as a disadvantage of this system that proper functionality can only be secured if the depth of the objects to be picked up is known in each case and that the distances to the next object have to be homogeneous as well. Another problem could be seen in the fact that such a system cannot avoid fork damage to goods which is to be picked up during the approach procedure, for example by a too high fork level.

Positioning of the forks is sometimes difficult when direct visibility is hindered by obstacles from the forklift truck, especially its lift pole, or by other obstacles in the surrounding, especially, if goods have to be picked up from high racks. The German utility model DE 20 2006 013 417 U 1 proposes a positioning aid for forklift trucks in which the position of the forks is visualized by the use of a laser which produces horizontal and vertical laser lines. This positioning aid however does not avoid damages to the object behind the object which is actually picked up. This might happen quite easily because the forks are usually longer than a normal palette and therefore protrude the palette. Because of statical reasons, it is preferred that objects to be carried by a forklift truck are put as close as possible to the cabin, which on the other hand enlarge the danger of the forks damaging the next object.

The Japanese Patent Application JP 2002 087793 describes the combination of supersonic sensors and spot-lasers mounted pair wise at the front end of each fork of a forklift truck. However, the visibility of laser points is relatively poor.

### SUMMARY

The subject innovation deals with a hybrid guidance system comprising a multipoint object collision warning and an optical positioning aid for a forklift truck.

From this technical background, the may provide an improved collision warning and guidance system for forklift trucks, which is easy to handle, reliable and may provide a higher degree of damage protection not only for the goods but for the forklift truck as well and therefore also helps to reduce the risk of accidents and personal injuries.

Moreover, the subject innovation relates to a guidance system for a forklift truck for lifting and moving goods placed on a palette with a lift pole which allows 20 vertical positioning of a lifting device which comprises a horizontal bar, to which at least two forks are parallel fixed, whereas the guidance system comprises
a) at least three rangefinder units for measuring range data,
b) at least one optical positioning aid and
c) a central processing unit to which the rangefinder units are connected, whereas one rangefinder unit is located at each front-end of the two forks and one rangefinder unit and one optical positioning aid are located at the horizontal bar of the lifting device.

The combination of three rangefinder sensors, two of which at the front-end tips of the forks and the third one at the base of the forks provides the possibility to measure very accurately the distance between objects and the forklift truck's forks and cabin. This enables the operator to put the goods as close as possible to the cabin without the danger of collision of the forks with an object behind the object which is actually picked up.

Different types of rangefinder sensors can be used in connection with the subject innovation, like laser rangefinders or supersonic rangefinders. It is possible to combine different types of rangefinders. For example, especially the rangefinders at the tip of the forks could be laser rangefinders if a fast response of the sensor and a focused measurement is favored. The rangefinder units are connected to a central processing unit which can process the signals of the sensors of the rangefinders into range data or values, which can be used to display the ranges in inches or centimeters on a display, which can be located inside the cabin of the forklift truck. The central processing unit can be a mini-computer and can be mounted at different positions, for example at the horizontal bar between the forks or within the cabin.

The optical positioning aid provides a high accuracy of approaching the goods or palettes in the first place so that in combination with the rangefinders, the guidance system according to this invention allows fast and very exact approach to palettes or goods, thus increasing the possible work-speed as well as the level of working security for personnel and machinery at the same time. The optical positioning aid can be any light source which produces light in the visible part of the radiation spectrum, although laser light sources are favored due to their better visibility and because of their parallel light-beam.

The rangefinder unit and optical positioning aid which are located at the horizontal bar of the lifting device can as well be positioned on other vertical parts of the lifting device. In these cases it should be ensured that rangefinder unit and optical positioning aid are coupled with the elevation adjustment of the forks.

A forklift truck according to the current invention can be any forklift with or without cabin, i.e. it is not to be understood as limited to forklift trucks in which the operator is sitting. Also construction machines equipped with forks are understood as forklift trucks in the sense of the current invention. The forks are parallel fixed to a horizontal bar. The distance between the forks can be fixed but as well be movably guided at the bar within the horizontal plane.

The system according to this invention can be powered by a battery or a rechargeable cell as well as it can be connected to the electric energy system of the forklift truck.

In a system according to the subject innovation, at least one of the rangefinder units comprises a supersonic rangefinder or a laser rangefinder sensor. Supersonic rangefinders have the advantage that they work reliably with a sufficient level of accuracy. If fast response of the sensor and a focused measurement is favored, the rangefinders can also be laser rangefinders. This is especially advantageous for the rangefinders at the frontend of the forks, as laser rangefinders are not so easily disturbed for example at low fork level by the ground due to their localized measuring area.

A further development of the system according to the subject innovation includes that the rangefinder unit located at the horizontal bar of the lifting device is mounted above the level of the forks. During loading the forks with the palette, this rangefinder securely determines the distance to the good which is positioned on the palette thus avoiding collision of the good with the cabin of the forklift truck.

According to the subject innovation, the optical positioning aid comprises a laser light source which emits laser light with a wavelength between 380 and 750 nm, especially a laser light source which produces a horizontal laser line. A laser line means that the laser produces a horizontally spreading beam which is detected as a horizontal line when the beam is reflected from an object in front of the laser. A laser line can be recognized more easily than laser dots, especially on uneven surfaces. As the laser line can be used as a reference for the level of the forks, it allows a more secure leveling of the forks while approaching a palette, thus avoiding damage to the palette or the good on top of the palette.

It is even more preferred in this context, if the optical positioning aid comprises a laser light source which emits laser light with a wavelength between 380 and 750 nm in the form of a cross (upstanding). This means that a light cross is visible when the laser beam hits a surface in front of it. Such a cross is even more practical as by chance the horizontal line might not be visible on the surface, for example a red laser-line on a red surface. In addition, the light source can be positioned exactly in the middle between the two forks and also mounted there in such a way that always follows the middle even if the forks are moved parallel to the forklift truck on a rail or if the forks are spread or put closer together. In such a case, the vertical part of the cross defines the middle between the forks to the operator of the forklift truck, thus simplifying the positioning of the forks in the middle of the palette which is actually approached.

It is even more preferred in such a case that at least one of the vertical branches of the light cross has a triangular shape which narrows in the direction of the center of the light cross. If the horizontal line is not visible, the triangular shape of the vertical branch of the cross indicates where the horizontal line is to be found. Of course it is possible as well to use a laser cross in which the vertical lines are triangular and broaden in the direction of the center of the light cross. It is as well possible to use triangular shapes on the horizontal lines to more easily indicate the middle of the cross.

This can be realized by using triangular shapes on the horizontal branches of the cross alone or in combination with triangular shapes on the vertical branches.

According to a preferred embodiment of the system according to the subject innovation, the laser light source is arranged in such a way that the horizontal line is always emitted parallel to the ground on the level of the surface of the forks or slightly above. Slightly above means in this context up to 3 cm above, preferred up to 1 cm above. This is advantageous because for the operator of the forklift truck, the level of the forks is always visible while approaching an object to be picked up. This allows a more secure leveling of the forks while approaching a palette also on high racks, thus avoiding damage to the palette or the good on top of the palette.

In a further development of the system according to the subject innovation, the laser light source provides two different light colors, especially with colors that differ in the RGB-color circle by equal or more than 45°, especially by equal or more than 90°. This is advantageous, because depending on the substrate of the goods to be picked up, the color of the palette or also depending on the color of the illumination of the building, the reflection of the optical positioning aid might be not or just poorly visible, for example a red colored laser beam on a red surface. Using at least two colors can avoid this problem. This can be achieved by a laser diode capable to produce at least two different colors or by using at least two diodes or laser light sources. They are practically arranged tightly, so that the light beams are close together or even completely overlap. The RGBcolor circle contains the colors of the visible spectrum arranged in a circle from yellow over magenta, blue and green back to yellow. Colors in opposite position in that circle, i.e. an angle of 180°, represent complementary colors.

In a further preferred embodiment of the system according to the subject innovation, a video-camera is fixed at the horizontal bar of the lifting device. The image of the camera can be transferred via cable or wireless to a monitoring device in the cabin of the forklift-truck. This is advantageous, because the operator can optically control the leveling of the forks also during pick-up of palettes from high racks. A camera is especially preferred, if the system is equipped with a laser as optical positioning aid.

A further development of the current system comprises that the measuring range of the rangefinder units is below or equal to about 2.0 m, especially below or equal to 1.8 m. This is advantageous because the measurements can be reduced to the important distances during the close approach of a palette with the forklift truck equipped with the system according to this invention. This is, especially preferred for the rangefinder sensors at the front-end of the forks.

To further enhance the detection accuracy of the system, the rangefinder units located at the front-end of the forks have a detection angle below or equal to 30°, preferably below or equal to 20°, more preferably below or equal to 10°. The detection angle is understood as the opening angle of that area which is detected by the sensor, for example from the outer left to the outer right side. This embodiment ensures that these rangefinders detect objects in front of the forks only, thus avoiding that while approaching a palette with the forks, these rangefinders detect a collision risk with the palette although the forks would enter the palette properly.

It is further preferred if the rangefinder unit located at the horizontal bar of the lifting device has a detection angle equal or above 25°, preferably equal or above 40°, more preferably equal or above 50°. This has the advantage that this sensor detects any object approaching the cabin of the forklift truck, also objects with a smaller profile or objects which have an uneven surface or shape.

According to another embodiment of the subject innovation, the central processing unit is connected to a monitoring device, which is preferably located inside the cabin of the forklift truck, for displaying the measuring data of the rangefinder units. This is advantageous because in such an arrangement, the detected and processed signals can be displayed in an appropriate way and easily visible by the operator of the forklift truck. This monitoring device can be used for displaying the picture of the optional camera as well.

It is preferred in this context, if the connection between the central processing unit and the monitoring device is established by a wireless data network, especially via Bluetooth. This is also true for the connection with the optional camera. The connection can also be established via conductive cable or by fiberoptic, but it is more preferred if the connection is established wireless, because the rangefinders and advantageously the central processing unit as well are located at movable parts of the forklift truck, i.e. somewhere at the lifting device, which makes a physical connection more complex.

It is further preferred, if the monitoring device is a flat screen monitor, especially a touch screen monitor, to ensure good visibility of the displayed measuring results with little space necessity.

It is also preferred in that context that the monitoring device is capable to display the measuring data of each rangefinder unit separately. This enables the operator to localize areas of possible collision. This also enables the operator to find out if one of the sensors is defect, which of these sensors is affected.

The readability of the displayed sensor data is even more enhanced, if the monitoring device is capable to display the measuring data graphically and/or numerically. It is even more preferred, if the monitoring device is capable to display the measuring data of the rangefinder unit located at the horizontal bar of the lifting device numerically in such a way that the front end tip of the forks is defined as zero-point of distance. In such an arrangement, the operator can immediately read, how far the palette or the good which is actually picked up is already reaching over the forks.

To increase transport security even more, the monitoring device is capable to display the ideal insertion depth of the forks into a palette. The ideal insertion depth can be programmed individually for different types and/or weights of goods or palettes. Ideal insertion depth means in this context the best penetration depth of the forks under the palette according to its weight and overall depth, thus minimizing possible damages on goods behind the palette and bringing the palette as close as possible to the cabin for a more secure transport. This can be practically achieved by markings on the monitor. The actual position of the good or palette on the forks may be displayed as a bar on the monitor. If the bar has reached the markings, the best penetration depth of the forks for transporting this palette or good is reached.

According to a preferred embodiment of the subject innovation, the system or the central processing unit further comprises an alert device, which is capable to send an acoustical and/or optical alert signal, if the measured data of at least one of the rangefinder units go below a first predetermined limit. This alert device can be a speaker and/or a warning light for example which might be connected to and addressed by the central processing device or the monitoring device to give the acoustic signal if the above mentioned situation occurs. This first predetermined limit shall warn the operator that a collision might occur if the current movement is continued.

In an embodiment of subject innovation, the system or the central processing unit is capable to interfere with the drive and/or breaking system of the forklift truck, if the measured data of at least one of the rangefinder units go below a second pre-determined limit. The active interference with the forklift truck may prevent damage by collision with goods or palettes but also helps to avoid injury to other workers as well. This interference might preferably be coupled with acoustical and/or optical alert signals as described above.

Another aspect of the subject innovation is the use of a system according to the subject innovation as positioning aid and collision warning system for forklift trucks.

### BRIEF DESCRIPTION OF THE DRAWINGS

The current invention is further presented with an example according to the following figures. It is shown in

FIG. 1 is a perspective view of a system according to an exemplary embodiment on the lifting device of a forklift truck; and

FIG. 2 is a diagram of an example display arrangement for visualization of the measured distances, detected by the rangefinder units, on a flat screen monitor.

### DESCRIPTION OF SPECIFIC EMBODIMENTS

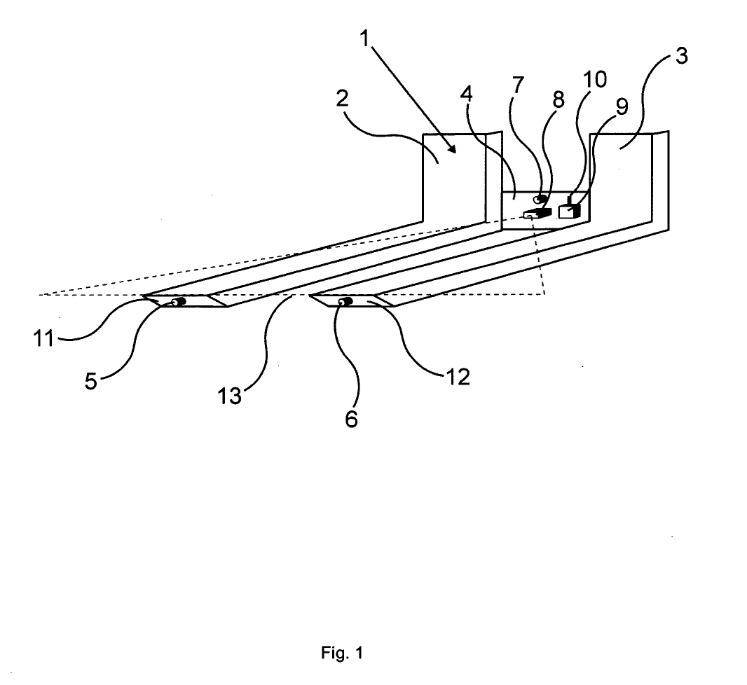

FIG. 1 displays a lifting device 1 of a forklift truck, which consists of two forks 2 and 3, parallel fixed on a horizontal bar 4. The lifting device 1 is equipped with a guidance system, consisting of three rangefinder units 5, 6 and 7, an optical positioning aid 8 and a central processing unit 9 to which the rangefinder units 5, 6 and 7 are connected (the connection is not displayed in FIG. 1). The central processing unit 9 comprises an antenna 10 for communication with a monitoring device located inside the cabin of the forklift truck. The rangefinder units 5 and 6 are mounted at the front-end 11 and 12 of the forks 2 and 3. The rangefinder 7 is mounted at the horizontal bar 4 exactly in the middle between the forks 2 and 3 and above the level of the forks 2 and 3. The optical positioning aid 8 is realized in form of a laser, positioned slightly above the level of the forks 2 and 3. The laser produces a horizontal laser line 13, indicated in FIG. 1 by the dotted line, to visualize the upper border of the forks 2 and 3.

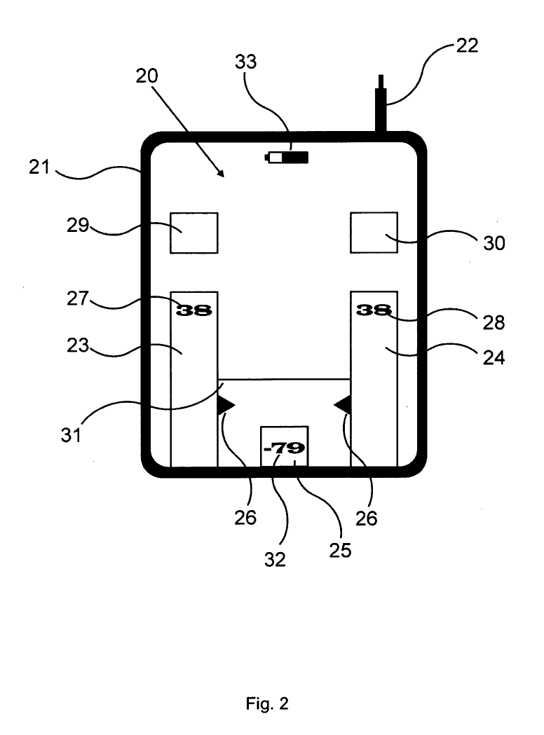

FIG. 2 shows the built-up of a monitoring device 20, in this case, a flat screen monitor with touch-screen functionality, for displaying the measuring data of the rangefinder units 5, 6 and 7 on a display 21, mountable inside the cabin of a forklift truck. The monitoring device 20 comprises an antenna 22 for receiving the processed measuring data from the central processing unit 9 via Bluetooth. The display 21 shows the schematic contours 23 and 24 of the forks 2 and 3 from the top view as well as the position 25 of the center rangefinder unit 7. Triangular indicators 26 indicate the ideal insertion depth of the forks 2 and 3 into a defined type of palette which is supposed to be picked up. The type of palette can be defined by the operator by using the touch-screen functionality of the flat-screen monitor. Inside the schematic contours 23 and 24, the measured distances from the front-end of the forks 2 and 3 is displayed numerically in centimeters 27 and 28, as measured by the rangefinder units 5 and 6, in FIG. 2 as example distances of 38 cm each. The objects detected in front of the forks 2 and 3 are displayed as boxes 29 and 30. The actual insertion depth of the forks 2 and 3 under the palette is indicated graphically by the bar 31 as well as numerically 32 inside the box 25 as measured by rangefinder unit 7. The displayed value 32 is given as negative value, as it reflects the insertion depth measured from the front-end of the forks 2 and 3 as point of zero, in FIG. 2, as current example, a distance of minus 79 cm. The display 21 further shows the actual battery status 33 of the central processing unit 9.

1-22. (canceled)

23. A forklift truck for lifting and moving goods placed on a palette, the forklift truck comprising:
a lifting device that is vertically positioned with a lift pole, the lifting device comprising a horizontal bar to which at least two parallel forks are fixed; and
a guidance system comprising:
at least one optical positioning aid;
a central processing unit to which the rangefinder units are connected; and
at least three rangefinder units for measuring range data, one of the at least three rangefinder unit being located at each front-end of the two forks, one of the at least three rangefinder units and one optical positioning aid being located at the horizontal bar of the lifting device.

24. The forklift truck recited in claim 1, wherein at least one of the rangefinder units comprises a supersonic rangefinder sensor or a laser rangefinder sensor.

25. The forklift truck recited in claim 1, wherein the rangefinder unit located at the horizontal bar of the lifting device is mounted above the level of the forks.

26. The forklift truck recited in claim 1, wherein the optical positioning aid comprises a laser light source that emits a horizontal laser line with a wavelength between 380 and 750 nm.

27. The forklift truck recited in claim 4, wherein the laser light source is arranged so that the horizontal line is always emitted parallel on or slightly above the level of the forks.

28. The forklift truck recited in claim 4, wherein the laser light source provides two different light colors that differ in an RGB-color circle by equal or more than 45°.

29. The forklift truck recited in claim 4, wherein the laser light source provides two different light colors that differ in an RGB-color circle by equal or more than 90°.

30. The forklift truck recited in claim 1, wherein the optical positioning aid comprises a laser light source that emits laser light with a wavelength between 380 and 750 nm in the form of an upstanding cross.

31. The forklift truck recited in claim 8, wherein at least one vertical branch of the cross has a triangular shape that narrows in the direction of the centre of the light cross.

32. The forklift truck recited in claim 1, comprising a video-camera fixed at the horizontal bar of the lifting device.

33. The forklift truck recited in claim 1, wherein a measuring range of the rangefinder units is less than or equal to about 2.0 meters.

34. The forklift truck recited in claim 1, wherein a measuring range of the rangefinder units is less than or equal to 1.8 meters.

35. The forklift truck recited in claim 1, wherein the rangefinder units located at the front-end of the forks have a detection angle less than or equal to 30°.

36. The forklift truck recited in claim 1, wherein the rangefinder units located at the front-end of the forks have a detection angle less than or equal to 20°.

37. The forklift truck recited in claim 1, wherein the rangefinder units located at the front-end of the forks have a detection angle less than or equal to 10°.

38. The forklift truck recited in claim 1, wherein the rangefinder unit located at the horizontal bar of the lifting device has a detection angle greater than or equal to 25°.

39. The forklift truck recited in claim 1, wherein the rangefinder unit located at the horizontal bar of the lifting device has a detection angle greater than or equal to 40°.

40. The forklift truck recited in claim 1, wherein the rangefinder unit located at the horizontal bar of the lifting device has a detection angle greater than or equal to 50°.

41. The forklift truck recited in claim 1, comprising a monitoring device connected to the central processing unit, the monitoring device being located inside a cabin of the forklift truck, the monitoring device displaying measuring data of the rangefinder units.

42. The forklift truck recited in claim 19, wherein the connection between the central processing unit and the monitoring device is established by a wireless data network.

43. The forklift truck recited in claim 20, wherein the wireless data network comprises Bluetooth network.

44. The forklift truck recited in claim 20, wherein the monitoring device comprises a flat screen monitor having a touch screen input device.

45. The forklift truck recited in claim 20, wherein the monitoring device displays measuring data of each rangefinder unit separately.

46. The forklift truck recited in claim 20, wherein the monitoring device displays measuring data graphically and/or numerically.

47. The forklift truck recited in claim 20, wherein the monitoring device displays the measuring data of the rangefinder unit located at the horizontal bar of the lifting device numerically in such a way that the front end of the forks is defined as a zero-point of distance.

48. The forklift truck recited in claim 20, wherein the monitoring device displays an ideal insertion depth of the forks in a palette.

49. The forklift truck recited in claim 1, wherein the system or the central processing unit comprises an alert device that sends an acoustical and/or optical alert signal if the measured data of at least one of the rangefinder units go below a first pre-determined limit.

50. The forklift truck recited in claim 27, wherein the system or the central processing unit overrides a drive and/or breaking system of the forklift truck if the measured data of at least one of the rangefinder units go below a second pre-determined limit.
